(19) United States
(12) Patent Application Publication
(10) Pub. No.: US 2013/0098453 A1
(43) Pub. Date: Apr. 25, 2013

(54) METHOD AND DEVICE FOR REFILLING AN EVAPORATOR CHAMBER

(71) Applicants: Raimund Boger, Bad Urad (DE); Andreas Jahnke, Munchen (DE); Thomas Götze, Grosstreben (DE)

(72) Inventors: Raimund Boger, Bad Urad (DE); Andreas Jahnke, Munchen (DE); Thomas Götze, Grosstreben (DE)

(21) Appl. No.: 13/576,388

(22) PCT Filed: Mar. 23, 2011
(86) PCT No.: PCT/EP2011/054433

§ 371 Date: Dec. 4, 2012

(30) Foreign Application Priority Data
Mar. 26, 2010 (EP) 10157912.6

(51) Int. Cl. F16L 53/00

(52) U.S. Cl. CPC F16L 53/00
USPC 137/1; 137/334

(57) ABSTRACT

Devices and methods for continuously refilling an evaporator chamber are described. The evaporator chamber includes a vacuum chamber having a partition that is permeable only to liquid material. The solid material can be heated in the vacuum chamber by a heating jacket of the vacuum chamber to liquefaction, and transferred via a drain and a connecting channel into a basin inside an evaporator chamber.

The invention relates to a method and a device for refilling an evaporator chamber, in particular for continuously refilling the evaporator chamber.

One of the advantages of thin-film solar cells compared to solar cells with crystalline or polycrystalline silicon is their great flexibility with regard to the substrate used and the size of the substrate to be coated. Thus, thin-film solar cells can also be produced in large areas on glass panes or on flexible materials, such as plastics, for instance.

Photovoltaic layer systems for the direct conversion of sunlight into electrical energy are sufficiently well known. The materials and the arrangement of the layers are coordinated such that incident radiation is converted directly into electrical current by one or a plurality of semiconducting layers with the highest possible radiation yield. Photovoltaic and extensive-area layer systems are referred to as solar cells.

Solar cells include, in all cases, semiconductor material. Solar cells that require carrier substrates to provide adequate mechanical strength are referred to as thin-film solar cells. Due to the physical properties and the technological handling qualities, thin-film systems with amorphous, micromorphous, or polycrystalline silicon, cadmium telluride (CdTe), gallium-arsenide (GaAs), or copper indium (gallium)-sulfur/selenium (CI(G)S) are particularly suited for solar cells.

Known carrier substrates for thin-film solar cells include inorganic glass, polymers, or metal alloys and can, depending on layer thickness and material properties, be designed as rigid plates or flexible films. Due to the widely available carrier substrates and a simple monolithic integration, large-area arrangements of thin-film solar cells can be produced cost-effectively.

Thin-film solar cells have, however, compared to solar cells with crystalline or multicrystalline silicon, a lower radiation yield and lower electrical efficiency. Thin-film solar cells based on Cu(In, Ga)(S, Se)₂ have electrical efficiencies that are roughly comparable to multicrystalline silicon solar cells. CI(G)S-thin-film solar cells require a buffer layer between a typically p-conducting CI(G)S-absorber and a typically n-conducting front electrode, which usually contains zinc oxide (ZnO). The buffer layer can effect an electronic adaptation between the absorber material and the front electrode. The buffer layer contains, for example, a cadmium-sulfur compound. A rear electrode with, for example, molybdenum, is deposited directly on carrier substrates.

An electrical circuit of a plurality of solar cells is referred to as a photovoltaic module or a solar module. The circuit of solar cells is durably protected from environmental influences in known weather-resistant superstructures. Usually, low-iron soda lime glasses and adhesion-promoting polymer films are connected to the solar cells to form a weather-resistant photovoltaic module. The photovoltaic modules can be integrated via connection boxes into a circuit of a plurality of photovoltaic modules. The circuit of photovoltaic modules is connected to the public supply network or to an independent energy supply via known power electronics.

The deposition of selenium, in particular in the sequential deposition of the components of the CIS layer, usually occurs in a vacuum. This requires a complete interruption of the process when the selenium provided for deposition is used up. The entire apparatus must be aerated, cooled, selenium refilled into the apparatus, and then re-evacuated and reheated. These steps are very time-consuming and, in large-scale production, very cost intensive since the evaporation process is, in any case, interrupted for a relatively long period of time. Because of these necessary steps, in particular the aeration and cooling processes, continuous selenium deposition is not possible. Since the size of the evaporation device and the selenium vapor concentration are important process parameters, it is, moreover, not possible to introduce an arbitrarily large amount of selenium into the selenium evaporator chamber. Moreover, the speed of uniform selenium evaporation also depends on a defined surface-to-volume ratio of the selenium to be evaporated.

WO 2007/077171 A2 discloses a method for producing chalcopyrite layers in CIGSS solar cells. For this, a substrate is coated with precursors and placed, together with sulfur and selenium in a sealingly closable reaction box. The reaction box is introduced into an RTP furnace, evacuated, and heated to the necessary reaction temperature.

EP 0 715 358 A2 discloses a method for producing a solar cell with a chalcopyrite absorber layer. In the method, a desired alkali content is established by adding Na, K, or Li. An additional diffusion of alkali ions out of the substrate is prevented by a diffusion barrier layer. Selenium and/or sulfur are added in the method at least partially via an appropriate sulfur- or selenium-containing atmosphere.

WO 2009/034131 A2 discloses a method for deposition of chalcogens in thin layers. The selenium is stored as a solid in a storage vessel and transferred from there into a chamber and evaporated. The chamber is provided at the inlet with a closure to prevent leakage of the selenium vapors into the storage vessel.

U.S. Pat. No. 4,880,960 A discloses a method for vacuum evaporation and a device for coating a movable substrate. The material to be applied is continuously transferred out of a storage reservoir via a valve into a vacuum chamber, heated, and deposited there on a substrate supported on rollers. The invention discloses the deposition coating of carbon fibers with magnesium.

WO 2009/010468 A1 discloses a device for evaporating solid materials. The solid material, for example, selenium, is introduced into a first crucible and melted. The molten material flows via a transport device into a second crucible. In this crucible, the molten material is evaporated and applied to a substrate. The filling of the material takes place into a reservoir that is closed after filling and then evacuated and lets the solid material pass via a valve to the first crucible.

The object of the present invention is to provide a method that enables continuous refilling of an evaporator chamber without interrupting the evaporation, in particular the evaporation of selenium, sulfur, tellurium, and/or mixtures thereof.

The object of the present invention is accomplished according to the invention by a method for continuously refilling an evaporator chamber according to claim 1 and a device according to claim 7. Preferred embodiments emerge from the subclaims.

Devices according to the invention and their use emerge from other coordinated claims.

The invention comprises a method for continuously refilling an evaporator chamber, wherein
a. solid material (1) is transferred via a vacuum lock (19) into a vacuum chamber (3), wherein the vacuum chamber (3) has a partition (28) that is permeable only to liquid material (1),
b. the material (1) is heated in the vacuum chamber (3) by a heating jacket (29) of the vacuum chamber (3) to liquefaction, and
c. the material (1) is transferred via a drain (21) and a connecting channel (20) into a basin (9) inside an evaporator chamber (8).

The method according to the invention for refilling an evaporator chamber comprises, alternatively, in a first step the filling of a preferably solid material via a feeder into a siphon inside a heated vacuum chamber. A vacuum slide attached between the feeder and the vacuum chamber and heated to 160° C. to 200° C. enables the opening and closing of the vacuum chamber. When the selenium feed is completed, the heated vacuum slide is closed. After the closing of the heated vacuum slide, the vacuum chamber has a pressure p₁ from application of a vacuum. The material situated in the siphon is liquefied by a heater in the vacuum chamber and can be transferred as a function of the pressure difference between the two ends of the siphon via a funnel connected to the end of the siphon into a basin of a connected evaporator chamber. The evaporator chamber and the outlet of the siphon have preferably a pressure p₂, with the pressure p₂ less than the pressure p₁ in the vacuum chamber at the intake of the siphon. The method for continuously refilling an evaporator chamber includes, alternatively, schematically the following step, wherein material is transferred via a feeder and a heated vacuum slide into the siphon inside a heated vacuum chamber, material is heated in the siphon to liquefaction, and material is transferred via a funnel connected to the outlet of the siphon into a basin inside an evaporator chamber.

The material preferably includes selenium, sulfur, iodine, bismuth, lead, cadmium, cesium, gallium, indium, rubidium, tellurium, thallium, tin, zinc, and/or mixtures thereof, particularly preferably sulfur, selenium, and/or tellurium, more particularly preferably selenium.

The temperature control of the heated vacuum slide is carried out preferably by a heated connector and/or a cooled connector attached on the vacuum slide.

The temperature control of the heated vacuum slide can, alternatively, also be carried out directly in the heated vacuum slide, preferably by means of an electrical resistance heater.

The heated vacuum slide and/or the heated connector are preferably maintained at a temperature of 160° C. to 200° C.

The cooled connector is preferably maintained at a temperature of 25° C. to 35° C.; this temperature prevents adhesion of the solid material on the connector.

The siphon is preferably heated to 200° C. to 250° C. to liquefy the material situated in the siphon.

The vacuum chamber is preferably evacuated to a pressure p₁ of 20 mbar to 10⁻⁶ mbar, preferably 10 mbar to 0.1 mbar.

The evaporator chamber is preferably evacuated to the pressure p₂ of 10⁻² mbar to 10⁻⁷ mbar.

The evaporator chamber is preferably heated to a temperature of 200° C. to 300° C., preferably 230° C. to 270° C.

The pressure p₁ in the vacuum chamber is preferably greater than the pressure p₂ in the evaporator chamber by at least 10¹ mbar, preferably by 10², particularly preferably by 10³ mbar.

The invention further includes an alternative device for continuously refilling an evaporator chamber. The device for continuously refilling an evaporator chamber includes a feeder for material with a heated vacuum slide attached to the feeder, a vacuum chamber attached to the heated vacuum slide with a siphon attached to the heated vacuum slide and with a heater, and an evaporator chamber attached to the vacuum chamber with a funnel attached to the siphon and with an evaporating basin attached under the funnel. The device includes specifically at least one feeder for preferably solid material and a heated vacuum slide attached to the feeder. A vacuum chamber is affixed to the heated vacuum slide. Inside the vacuum chamber, a siphon is connected to the heated vacuum slide, and the opening of the heated vacuum slide enables refilling the siphon with preferably solid material from the feeder. A heater installed in the vacuum chamber enables heating and liquefying the material situated in the siphon. In an evaporator chamber attached to the vacuum chamber, a funnel is connected to the outlet of the siphon. The funnel is connected to an evaporation basin situated in the evaporator chamber. The evaporation basin enables the evaporation of the liquid material introduced via the funnel.

The siphon preferably contains a liquid. The liquid prevents penetration of material vapors from the evaporator chamber into the vacuum chamber. The liquid, moreover, enables the setting of different pressure levels in the vacuum chamber and the evaporator chamber. For the rise, i.e., for the difference in the height of the liquid columns in the legs of the siphon, the following equation (1) applies:

$$Δ h = \frac{Δ p}{ρ * g} , \qquad ( 1 )$$

with Δp=pressure difference between the evaporator chamber and the vacuum chamber (Pa), Δh=level difference in the legs of the siphon (mm), ρ=density of the liquid (g/cm³) and g=gravitational constant (9.81 m/s²).

The liquid includes preferably selenium, sulfur, iodine, bismuth, lead, cadmium, cesium, gallium, indium, rubidium, tellurium, thallium, tin, zinc, and/or mixtures thereof, particularly preferably selenium. The liquid preferably has a melting point of less than 450° C. and a vapor pressure of less than 5 mbar at the melting point. The liquid closes the vacuum chamber off from the evaporator chamber and enables the setting of different pressure levels in the two chambers. The liquid preferably corresponds in its composition to the solid material and enables continuous refilling of the evaporator chamber.

The heated vacuum slide preferably has an opening with a diameter of 15 mm to 50 mm, preferably 30 mm to 40 mm. The permeability to the material is regulated by shifting the opening in the heated vacuum slide.

The heated vacuum slide is preferably connected above in the direction of the feeder to a cooled connector and/or below in the direction of the vacuum chamber to a heated connector.

The cooled connector and/or the heated connector preferably include a perforated plate with an opening and a heater or cooler, a mechanical counter-bearing, a closure, a slide, and a slide housing. The slide housing and the slide are attached externally on the cooled connector and/or on the heated connector. The slide is connected via a bore on the slide housing and connector to the interior of the connector. The perforated plate and the closure enable, depending on the position of the slide, permeability or impermeability to the material as well as setting of the vacuum or aeration of the adjacent connectors. The slide is preferably connected directly to the closure. When the opening in the closure and the opening in the perforated plate are aligned one above the other, the arrangement is permeable to the material. Otherwise, the opening in the closure and the opening in the perforated plate have no common coverage; thus, the arrangement is impermeable to the material. The cooler and/or heater is preferably disposed in the form of a cooling loop or electrical resistance heater on the perforated plate and/or the closure, particularly preferably extensively around the opening in the perforated plate and/or opening in the closure. The arrangement made of the perforated plate and closure are [sic] disposed preferably at a 90° angle relative to the direction of introduction of the material.

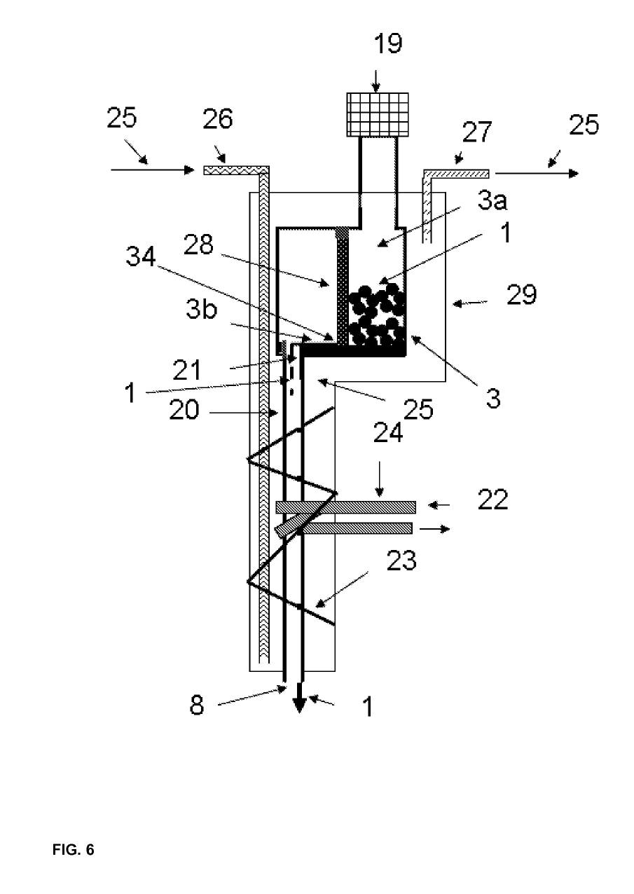

The invention further includes a device for continuously refilling an evaporator chamber:
d. a vacuum lock for solid material,
e. a vacuum chamber attached to the vacuum lock, wherein the vacuum chamber is provided with a partition that is permeable only to liquid material,
f. a connecting channel into an evaporator chamber attached to the vacuum chamber behind the partition,
g. a heating jacket of the vacuum chamber and of the connecting channel, and
h. a switchable cooling device on the connecting channel.
   The device includes a vacuum lock for solid material and a vacuum chamber attached to the vacuum lock. In principle, any type of lock arrangement can be used to transfer solid material into the vapor chamber. The lock arrangement must be stable against the pressure difference of atmospheric pressure and the vacuum in the evaporator chamber. The vacuum lock preferably includes a cooled connector, a heated vacuum slide, and/or a heated connector. The vacuum chamber is provided with a partition. The partition preferably has a slot at the bottom of the vacuum chamber that is permeable only to liquid material. This variant behaves exactly like a siphon when the partition in the vacuum chamber is fixedly welded in, has a perforation only right at the bottom, and the connecting channel reaches higher up than this perforation (cf. FIG. 6). The pressure balance on the two sides of the partition must be controlled such that in the event of overheating and possible evaporation of the liquid material, no strong uncontrolled transport of material into the connecting channel occurs. Alternatively, the partition can be configured as a porous wall that is permeable to liquid material. The passage of small solid particles is not problematic in this context. A connecting channel into an evaporator chamber is attached to the vacuum chamber. The partition separates the filling region of the evaporator chamber from the region of the vacuum chamber where the connecting channel is connected. A heating jacket surrounds the vacuum chamber and the connecting channel. The heating jacket is preferably implemented in the form of a heating bath, particularly preferably a circulatable heating bath. A switchable cooling device is attached to the connecting channel. The switchable cooling device is preferably disposed locally around the connecting channel in the form of tubes. Here, the expression “locally” refers only to a subregion of the connecting channel, preferably 1% to 30%, particularly preferably 2% to 8% of the surface of the connecting channel. When the coolant flow is switched on, the connecting channel is cooled in the region of the switchable cooling device and thus causes a congealing of the liquid material. The congealed material closes the vacuum chamber off from the evaporator chamber. When the coolant flow is switched off, the material becomes liquid again and the vacuum chamber is connected directly to the evaporator chamber via the connecting channel. The switchable cooling device can also be implemented as a heating jacket that can be switched off locally. In this case, a “bypass” for the circulatable heating bath ensures the lowering of the temperature and the congealing of the liquid material at a specific location.

The heating jacket preferably contains a heating fluid, preferably a temperature-resistant mineral oil and/or silicone oil.

The heating jacket preferably has a filling device and a purging device. The filling device and the purging device are preferably tubular and are preferably connected to a pump, preferably an oil pump. The pump enables circulation of a heating fluid in the heating jacket. Inside a container heat-resistant in the range from 150° C. to 350 C, the heating fluid preferably flows directly around the vacuum chamber and the connecting channel and thus enables constant temperature control. The heating jacket can, even intensely, supply heat from the outside in the region of the partition to accelerate liquefaction of the material filled as a solid in the region of the partition.

The vacuum chamber, the connecting channel, the filling device, and/or purging device preferably include a coating made of enamel and/or teflon.

The heating jacket preferably includes a spiral plate. The spiral plate is particularly preferably disposed in the region of the connecting channel in the heating jacket and enables additional heating of the connecting channel. The spiral plate can even serve for liquefaction of the solid material present in the region of the switchable cooling device when the cooling is turned on.

The partition includes preferably a metal or carbon, particularly preferably graphite. The partition can also be made of teflon. The partition can also be configured in the form of a net or honeycomb; the openings are preferably implemented such that they retain solid material and are permeable to liquid material.

The cooling device preferably contains a coolant. The coolant is preferably pumped through the cooling device via a cryostat and a circulating pump. The coolant preferably contains organic and/or inorganic solvents, preferably glycol, ethylene glycol, and/or water or cold gas, preferably carbon dioxide or nitrogen.

The invention further includes the use of the device according to the invention for continuously filling an evaporator chamber for sulfur, selenium, tellurium, and/or mixtures thereof.

The invention further includes the use of the device for continuously refilling a selenium evaporator chamber in the production of thin-film solar cells.

The invention is explained in detail in the following with reference to drawings. The drawings are purely schematic and not true to scale. The drawings in no way restrict the invention.

They depict:

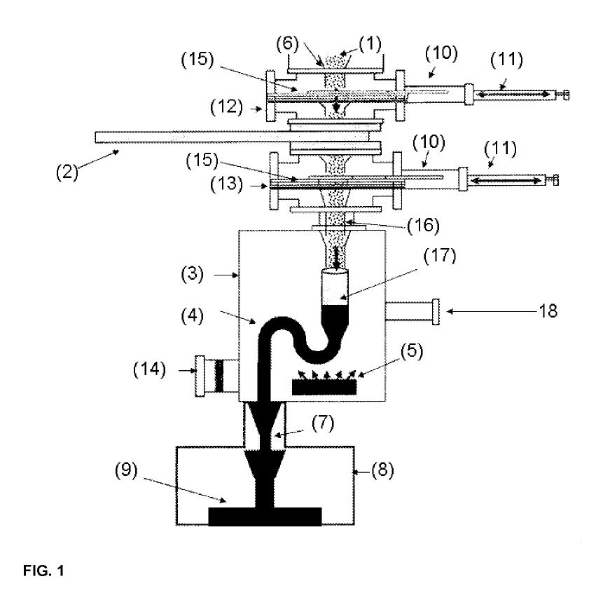

FIG. 1 a cross-section of a preferred embodiment of the device according to the invention,

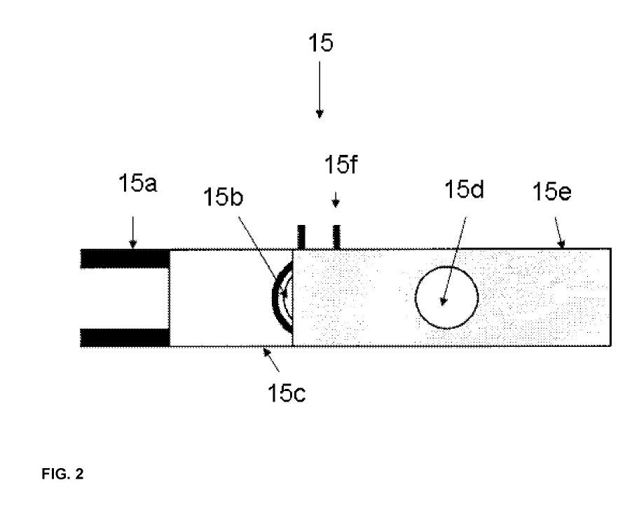

FIG. 2 a schematic of the individual components of the cooling/heating device (15),

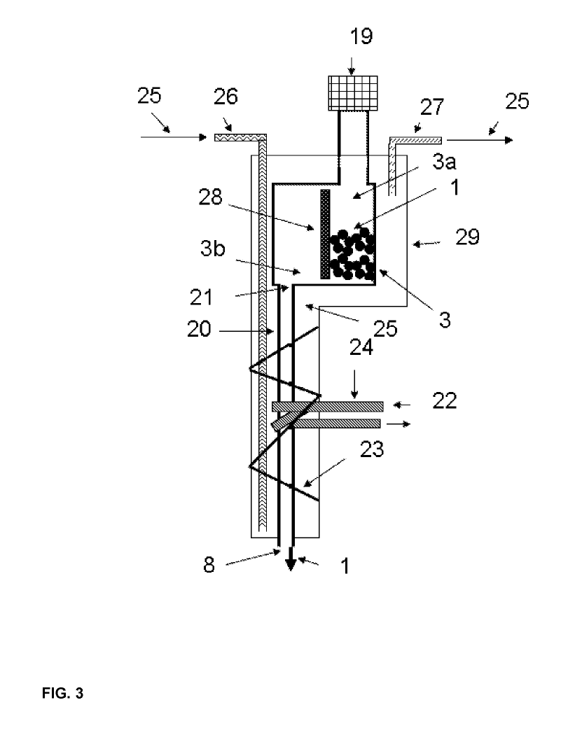

FIG. 3 a cross-section of an alternative embodiment of the device according to the invention,

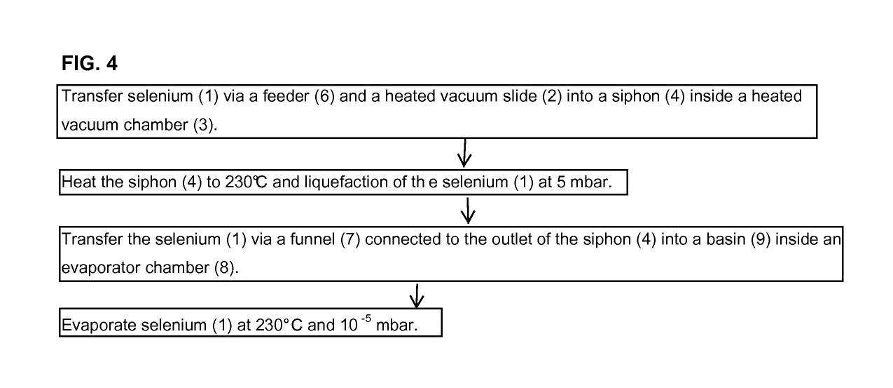

FIG. 4 a flow diagram of a preferred embodiment of the method according to the invention,

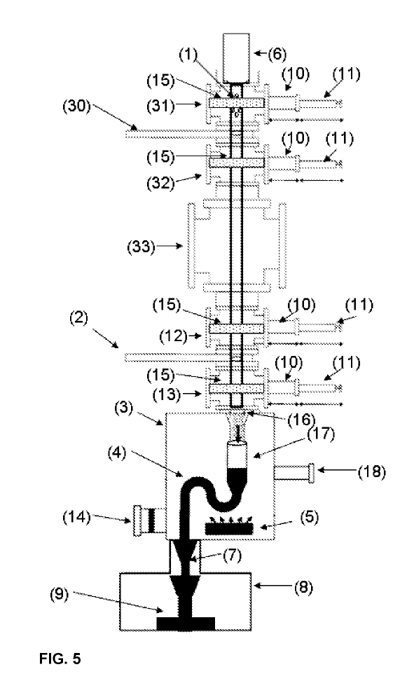

FIG. 5 a cross-section of another preferred embodiment of the device according to the invention, and

FIG. 6 a variant of the representation of FIG. 3.

FIG. 1 depicts a cross-section through a preferred embodiment of the device according to the invention. Selenium (1) is filled, as material (1), via the feeder (6) into the device according to the invention and conveyed to the evaporator (8). In order not to influence the vacuum in the evaporator chamber (8), the addition of the selenium (1) to the evaporator chamber (8) takes place via a heated vacuum slide (2). The device according to the invention comprises, after the feeder (6), a cooled connector (12), a heated vacuum slide (2), and a heated connector (13). The cooled connector (12) prevents adhesion of the solid selenium (1) during filling. The heated connector (13) prevents condensation of the gaseous selenium (1) out of the device according to the invention. The connectors (12,13) are configured as cross fittings with the dimensions 210 mm×210 mm. The cooled connector (12) and the heated connector (13) contain a slide housing (10) in a length of 75 mm as well as a slide (11) in a length of 105 mm. The slide (11) can be displaced to a length of 50 mm inside slide housing (10). The slide (11) can regulate the permeability to selenium (1) inside the device. Thus, by selective opening or closing of the slides (11) and the cooling/heating device (15) connected thereto, the individual sections of the device can be permeable to selenium or not. The heated vacuum slide (2) regulates the pressure and serves for evacuation and aeration. Thus, the vacuum chamber (3) can be evacuated when the cooled connector (12), the heated vacuum slide (2), and the heated connector (13) are closed in the direction of the evaporator chamber (8). The mode of operation of the cooling/heating device (15) is explained in FIG. 2. The two connectors (12/13) regulate or block the permeability of the selenium (1) and their temperature is controlled via the cooling/heating device (15). The heated vacuum slide (2) regulates the pressure. After passing through the heated connector (13), the selenium (1) arrives via a feed channel (16) into a siphon (4) in a vacuum chamber (3). The vacuum chamber (3) can be evacuated via a connector (18). A heater (5) heats the selenium (1) situated in the siphon (4). The height of the liquid column (17) of the selenium (1) results from the pressure difference between the vacuum chamber (3) and the evaporator chamber (8) connected thereto. The height of the liquid column can be monitored through a viewing window (14). The siphon (4) is connected via a funnel (7) in the evaporator chamber (8) to a basin (9) for evaporation of the selenium (1).

The device for continuously refilling an evaporator chamber alternatively comprises (not shown):
a. a vacuum lock (19) for solid material (1),
b. a vacuum chamber (3) attached to the vacuum lock (19), wherein the vacuum chamber (3) is provided with a partition (28) that is permeable only to liquid material,
c. a connecting channel (20) into an evaporator chamber (8) attached to the vacuum chamber (3) behind the partition (28),
d. a heating jacket (29) of the vacuum chamber (3) and of the connecting channel (20), and
e. a switchable cooling device (24) on the connecting channel (20).

The siphon (4) contains a liquid, preferably selenium, sulfur, iodine, bismuth, lead, cadmium, cesium, gallium, indium, rubidium, tellurium, thallium, tin, zinc, and/or mixtures thereof, particularly preferably contains selenium.

The cooled/heated connectors (12/13) and/or the heated vacuum slide (2) have an opening (15d) with a diameter of 15 mm to 50 mm, preferably 30 mm to 40 mm.

The heated vacuum slide (2) is connected above to a cooled connector (12) and/or below to a heated connector (13).

The cooled connector (12) and/or the heated connector (13) include a perforated plate (15c) with an opening (15b) and heater/cooler (15f), a mechanical counter-bearing (15a), a closure (15e), a slide (11), and a slide housing (10).

FIG. 2 depicts a schematic of the cooling/heating device (15) in the half closed state. A perforated plate (15c) is disposed on a mechanical counter-bearing (15a). The opening in the perforated plate (15b) is surrounded by a cooler or heater (15f). The closure (15e) with the opening in the closure (15d) regulates the permeability of the cooling/heating device (15) to the material (1). When the opening in the perforated plate (15b) and the opening in the closure (15d) are aligned one over the other, the cooling/heating device (15) is permeable, and, accordingly, impermeable, when the closure (15e) is positioned closed above the opening in the perforated plate (15b). The cooling/heating device (15) is, as depicted in FIG. 1, preferably disposed at a roughly 90° angle relative to the filling direction of the material (1), with the opening in the perforated plate (15b) situated perpendicular to the filling direction of the material (1). The position of the closure (15e) over the perforated plate (15c) is regulated via the arrangement comprising the slide (11) and the slide housing (10) described in FIG. 1. The slide (11) is preferably directly connected to the closure (15e).

FIG. 3 depicts a cross-section of a preferred alternative embodiment of the device according to the invention. Selenium (1) arrives via a vacuum lock (19) into a vacuum chamber (3). The vacuum chamber (3) is divided by a partition (28) into two regions (3a/3b). Following the vacuum lock (19), the selenium filled (1) is situated in front of the partition (28) in the filling region (3a) of the vacuum chamber (3). The partition (28) is permeable only to liquid selenium. A heating jacket (29) heats and liquefies the selenium (1), such that the selenium (1) can pass through the partition (28) and arrives in the outflow region (3b). The heating jacket (29) preferably includes an outer casing made of metal, preferably iron, chromium vanadium aluminum [sic], titanium, and/or stainless steel, in which the heating fluid (25) and the arrangement comprising the vacuum chamber (3) and the connecting channel (20) are situated. The heating jacket (29) includes a filling device (26) and a discharging device (27), via which the heating fluid (25), for example, a high-temperature-stable silicone oil, can be circulated inside the heating jacket (29). The liquid selenium (1) arrives via a drain (21) into the connecting channel (20) and into the evaporator chamber (8) (not shown). A switchable cooling device (24) attached to the connecting channel (20) can, when the coolant flow (22) is switched on, solidify liquid selenium (1) in the connecting channel (20) and seal the connecting channel (20). A spiral plate (23) attached to the heating jacket (29) in the region of the connecting channel (20) forces a flow of the heating fluid (25), which re-heats the connecting channel (20) when the cooling device (24) is switched off. The spiral plate (23) can also be used for the liquefaction of the solid selenium (1) located in the region of the switchable cooling device (24).

FIG. 4 depicts a flow diagram of a preferred embodiment of the method according to the invention. In a first step, solid selenium (1) is transferred via a feeder (6) into a siphon (4) inside a heated vacuum chamber (3). A vacuum slide (2) attached between the feeder (6) and the vacuum chamber (3) and heated to 160° C. to 200° C. enables the opening and closing of the vacuum chamber (3). When the selenium feed is completed, the heated vacuum slide (2) is closed. After the closing of the heated vacuum slide (2), the vacuum chamber (3) has a pressure of 5 mbar from application of a vacuum. The selenium (1) situated in the siphon (4) is liquefied by a heater (5) in the vacuum chamber (3) at 230° C. and is be transferred vis a funnel (7) connected to the end of the siphon (4) into a basin (9) of a connected evaporator chamber (8). The evaporator chamber (8) and the outlet of the siphon (4) preferably have a pressure of 10⁻⁵ mbar and a temperature of 230° C.

FIG. 5 depicts a cross-section of another preferred embodiment of the device according to the invention. The structure of the device corresponds to that described in FIG. 1, with the difference that between the feeder (6) and the cooled connector (12), a first cooled connector (31), a cooled vacuum slide (30), a second cooled connector (32), and a middle connector (33) are disposed.

FIG. 6 depicts an alternative embodiment of FIG. 3. This variant behaves exactly like a siphon when the partition (28) in the vacuum chamber (3) is fixedly welded in, has a perforation (34) only right at the bottom, and the connecting channel (20) reaches higher up than this perforation (cf. FIG. 6). The pressure balance on the two sides of the partition (28) must be controlled such that in the event of overheating and possible evaporation of liquid material, no strong uncontrolled transport of material into the connecting channel occurs.

### EXAMPLE

Continuous selenium refilling can take place, for example, as follows.
1. Solid selenium (1) is filled into the feeder (6) (1 atm, 30° C., 300 g, every 5 min)
2. The middle connector (33), two cooled connectors (32), and cooled connector (12) are aerated from 5 mbar to 1 atm.
3. Opening the cooled vacuum slide (30) and the slide (11) in the first cooled connector (31).
4. Opening the slide (11) in the second cooled connector (32), so the solid selenium (1) can drop into the vacuum lock, made of the second cooled connector (32), the middle connector (33), and cooled connector (12). The solid selenium (1) drops through the cooled vacuum slide (30), through the second cooled connector (32), and through the middle connector (33) onto the slide (11) in the cooled connector (12) (1 atm and 30° C., in each case 300 g every 5 min).
5. Closing the slide (11) in the first cooled connector (31) and closing the cooled vacuum slide (30) and the slide (11) in the second cooled connector (32).
6. The middle connector (33), second cooled connector (32), and cooled connector (12) with solid selenium (1) are evacuated from 1 atm to 5 mbar.
7. Opening the heated vacuum slide (2) and the slide (11) in the first heated connector (13).
8. Opening the slide (11) in the cooled connector (12) so the solid selenium (1) can drop into the siphon (4). The solid selenium (1) (in each case 300 g every 5 min) drops through the heated vacuum slide (2) through the heated connector (13) at 160° C. into the siphon (4) at 230° C. and 5 mbar.
9. Heating the solid selenium (1) in the siphon (4) with the heater (5) until it melts at 230° C. and 5 mbar.
10. Continuous flowing of the liquid selenium (1) from the siphon (4) through the heated funnel (7) into the basin (9) of the evaporator chamber (8) at 10⁻ mbar and 230° C.

### LIST OF REFERENCE CHARACTERS

(1) Material/selenium
(2) Heated vacuum slide
(3) Vacuum chamber
(4) Siphon
(5) Heater
(6) Feeder
(7) Funnel
(8) Evaporator chamber
(9) Basin
(10) Slide housing
(11) Slide
(12) Cooled connector
(13) Heated connector
(14) Viewing window
(15) Cooling/heating device
(15a) Mechanical counter-bearing
(15b) Opening in the perforated plate
(15c) Perforated plate
(15d) Opening in the closure
(15e) Closure
(15f) Cooler/heater
(16) Feed channel
(17) Height of the liquid column
(18) Connector
(19) Vacuum lock
(20) Connecting channel
(21) Drain
(22) Coolant
(23) Spiral plate
(24) Cooling device
(25) Heating fluid
(26) Filling device
(27) Discharging device
(28) Partition
(29) Heating jacket
(30) Cooled vacuum slide
(31) First cooled connector
(32) Second cooled connector
(33) Middle connector, and
(34) Opening in the partition.

1. A method for continuously refilling an evaporator chamber, the method comprising:
transferring a solid material via a vacuum lock into a vacuum chamber, wherein the vacuum chamber has a partition that is permeable only to liquid material;
heating the material in the vacuum chamber by a heating jacket of the vacuum chamber to liquefaction; and
transferring the material via a drain and a connecting channel into a basin inside an evaporator chamber.

2. The method according to claim 1, wherein the material comprises: selenium, sulfur, bromine, iodine, bismuth, lead, cadmium, cesium, gallium, indium, rubidium, tellurium, thallium, tin, zinc, and/or mixtures thereof.

3. The method according to claim 1, wherein the vacuum chamber is maintained at 160° C. to 250° C.

4. The method according to claim 1, wherein the vacuum chamber is evacuated to a pressure of 20 mbar to 10⁻⁶ mbar.

5. The method according to claim 1, wherein the evaporator chamber is evacuated to a pressure of 10⁻² mbar to 10⁻⁷ mbar.

6. The method according to claim 1, wherein the evaporator chamber is heated to a temperature of 200° C. to 300° C.

7. A device for continuously refilling an evaporator chamber comprising:
a vacuum lock for solid material;
a vacuum chamber attached to the vacuum lock, wherein the vacuum chamber is provided with a partition that is permeable only to liquid material;
a connecting channel into an evaporator chamber attached to the vacuum chamber behind the partition;
a heating jacket of the vacuum chamber and of the connecting channel; and
a switchable cooling device on the connecting channel.

8. The device according to claim 7, wherein the partition contains a metal or carbon.

9. The device according to claim 7, wherein the partition is configured in form of a net or honeycomb.

10. The device according to claim 7, wherein the heating jacket includes a spiral plate.

11. The device according to claim 7, wherein the heating jacket contains a heating fluid.

12. The device according to claim 7, wherein the vacuum chamber, the connecting channel, a filling device, and/or a purging device include a coating made of enamel and/or teflon.

13. A method comprising: using the device according to claim 7 for continuously refilling the evaporator chamber with sulfur, selenium, tellurium, and/or mixtures thereof.

14. A method comprising: using the device according to claim 7 for continuously refilling a selenium evaporator chamber in the production of thin-film solar cells.

15. The method according to claim 1, wherein the vacuum chamber is evacuated to a pressure of 10 mbar to 0.1 mbar.

16. The method according to claim 1, wherein the evaporator chamber is heated to a temperature of 230° C. to 270° C.

17. The device according to claim 7, wherein the partition contains graphite.

18. The device according to claim 7, wherein the heating jacket contains a temperature-resistant mineral oil and/or silicone oil.
